(19) United States
(12) Patent Application Publication
(10) Pub. No.: US 2008/0137643 A1
(43) Pub. Date: Jun. 12, 2008

(54) ACCESSING CALL CONTROL FUNCTIONS FROM AN ASSOCIATED DEVICE

(75) Inventors: Niraj Khanchandani, Mercer Island, WA (US); Anton Krantz, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MICROSOFT CORPORATION, Redmond, WA (US)

(21) Appl. No.: 11/608,728

(22) Filed: Dec. 8, 2006

(51) Int. Cl. H04L 12/66

(52) U.S. Cl. 370/352

(57) ABSTRACT

Aspects of the present invention are directed at integrating the functions of a computer and an IP phone without requiring an intermediary computing device to manage the exchange of control information. In accordance with one embodiment, a method is provided for initiating a call from a computer that remotely accesses functions on an IP phone. More specifically, the method includes causing one or more functions executed on the IP phone to be exposed to the computer. In response to receiving a request from a computer to initiate the call, the method causes a first control message to be transmitted from the computer to the IP phone. In this regard, the first control message is configured to access a function exposed on the IP phone for generating the call to the remote user. Then, the first control message is converted into a second control message that is transmitted over an IP data network to the remote user.

### BACKGROUND

Generally described, an Internet telephony system provides an opportunity for users to have a call connection with enhanced calling features compared to a conventional Public Switched Telephone Network (PSTN) based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services. In this regard, VoIP technology provides some of the infrastructure for a computing device to control another device or appliance. For example, media-specific computing devices such as IP phones have been developed to transmit audio data over IP data networks. However, a deficiency with existing systems is an inability to easily control functions provided by an IP phone from a related device, such as a desktop or laptop computer. For example, a user may want to employ a computer to generate events on an IP phone, such as entering numeric digits and ultimately initiating a call conversation.

Another deficiency with existing systems is an inability to receive notice of events that correspond to a call conversation on an IP phone from an associated computer. For example, a user may want to receive notice of an incoming call on a computer through a pop-up window or similar graphically-based mechanism. Similarly, when a user interacts with an IP phone to generate events, it may be desirable to have a software program be able to process these events. These and other deficiencies limit the use of certain devices, such as IP phones, that provide features desired by users.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at integrating the functions of a computer and an IP phone without requiring an intermediary computing device to manage the exchange of control information. In accordance with one embodiment, a method is provided for initiating a call from a computer while audio data is transmitted using an associated IP phone. More specifically, the method includes causing one or more functions executed on the IP phone, including a function to initiate a call, to be exposed to the computer. In response to receiving a request from the computer to initiate the call, the method causes a first control message to be transmitted from the computer to the IP phone. In this regard, the first control message is configured to access the function exposed on the IP phone to initiate the call. Then, the first control message is converted into a second control message that is transmitted over an IP data network to the remote user. As a result, a call may be initiated from controls accessed from a computer.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a networking environment in which aspects of the present invention may be implemented;

FIG. 2 illustrates another networking environment in which aspects of the present invention may be implemented;

FIG. 3 illustrates a set-up routine that performs processing to integrate computer and telephony functions in accordance with one embodiment of the present invention;

FIGS. 4A-4B illustrate a routine for establishing a call between users in accordance with another embodiment of the present invention;

FIGS. 5A-5C illustrate an exemplary exchange of control information for performing various functions that are supported by the present invention; and

FIG. 6 illustrates a networking environment capable of supporting a network conference in which aspects of the present invention may be implemented.

### DETAILED DESCRIPTION

Prior to discussing the details of the invention, it should be understood that the following description is presented largely in terms of logic and operations that may be performed by conventional computer components. These computer components, which may be grouped in a single location or distributed over a wide area, generally include computer processors, memory storage devices, display devices, input devices, etc. In circumstances where the computer components are distributed, the computer components are accessible to each other via communication links.

The network infrastructure and processes that enable a computing device to control another associated device is being developed and will continue to experience innovation. Aspects of the present invention provides infrastructure and processes in this area by enabling a device to control an associated device in the context of a telephone call. For example, processes provided by the invention allow a computer (e.g. desktop, PDA, SmartPhone, entertainment system, or any other device capable of sending data on an IP data network) to control an associated IP phone that maintains a direct connection to the IP data network.

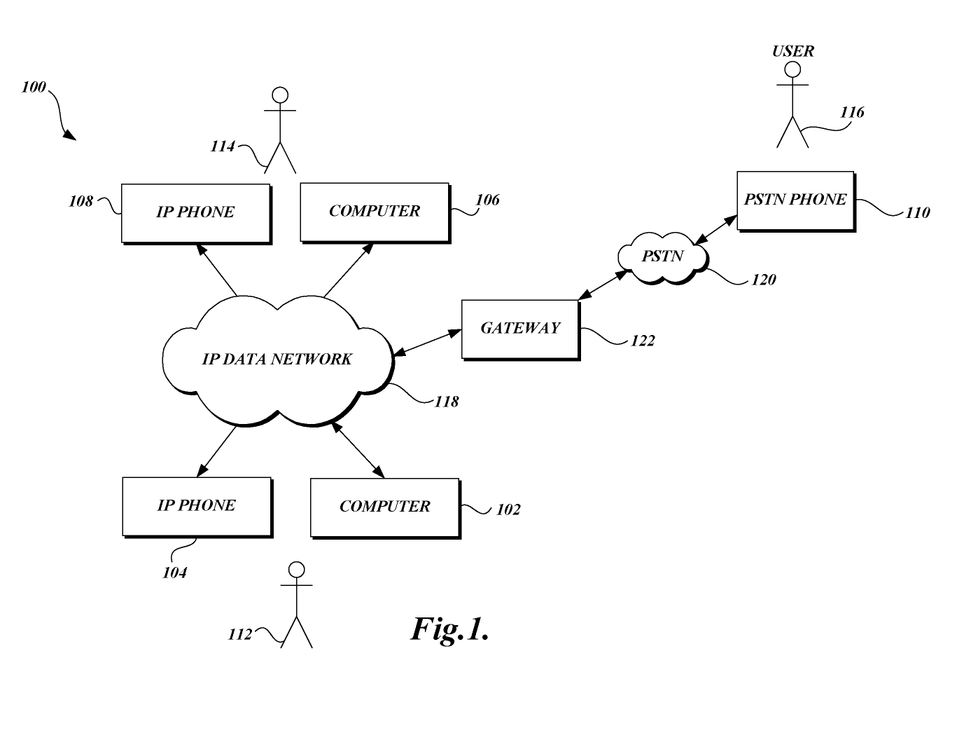

With reference to FIG. 1, a block diagram of a networking environment 100 for providing IP telephone services between various devices is shown. In this regard, the networking environment 100 includes the computer 102 and IP phone 104 that are each associated with the user 112. Similarly, the networking environment 100 depicted in FIG. 1 includes the computer 106 and IP phone 108 that are each associated with the user 114. Also depicted in FIG. 1 is the PSTN phone 110 that is associated with the user 116.

Generally described, the networking environment 100 may include an IP data network 118 such as the Internet, an intranet network, a wide area network (WAN), a local area network (LAN), and the like. In this regard, network endpoints may be configured to establish and maintain conversation channels over the IP data network 118. Further, each of the devices 102-108 may communicate with the PSTN phone 110 via the PSTN 120. A gateway 122 may provide access between the PSTN 120 and the IP data network 118. In this regard, those skilled in the art and others will recognize that the gateway 122 may translate IP data packets into circuit switched network data suited for transmission over the PSTN 120 and vice versa. In this way, the gateway 122 enables communications between the devices 102-108 and the PSTN phone 110.

In traditional systems, an intermediary computing device such as computer supported telecommunications application (“CSTA”) gateway coordinated the exchange of control information between paired devices. For example, to notify the computer 102 of events that occur on the IP phone 104, one or more intermediary computing devices has traditionally been used to receive, process, and forward messages between the IP phone 104 and the computer 102. In accordance with one embodiment, aspects of the present invention implement functionality that allows paired computing devices, such as the computer 102 and IP phone 104, to exchange data that relates to a call without requiring an intermediary computing device to manage the exchange of control information.

In one exemplary embodiment, aspects of the present invention expose functionality available from an IP phone to a paired computer. For example, the user 112 may interact with software-based controls presented on the computer 104 to initiate a call. Accordingly, a user who will receive an incoming call (e.g. user 114) may be identified using software-based controls presented on the computer 102 Then, functionality provided by the present invention may be applied to initiate a call when, for example, a “call” button that is accessible from the computer 102 is selected by the user 112. Once the call has been initiated, the users 112-114 may employ the IP phones 104 and 108, to communicate audio data. In addition to coordinating the initiation of a call, aspects of the present invention allow a user to employ a computer to increase/decrease volume, establish a conference call, mute/restore volume, place another user on hold, resume a held call, and the like.

In another embodiment, a computer is notified of events that occur on the IP phone. For example, the IP phone 108 may receive an incoming call from another user. When the call is received, the invention may be applied to transmit a message over a secure communication channel from the IP phone 108 to the computer 106 so that a graphically-based control may be presented to visually notify the user 114 of the incoming call. Accordingly, a software application on the computer 106 may process the received message so that a pop-up window with information relevant to the call may be displayed. In addition to call alerting, aspects of the present invention establish communication primitives that allow a computer to receive notice when a call is answered, disconnected, held/resumed, and the like from a paired device.

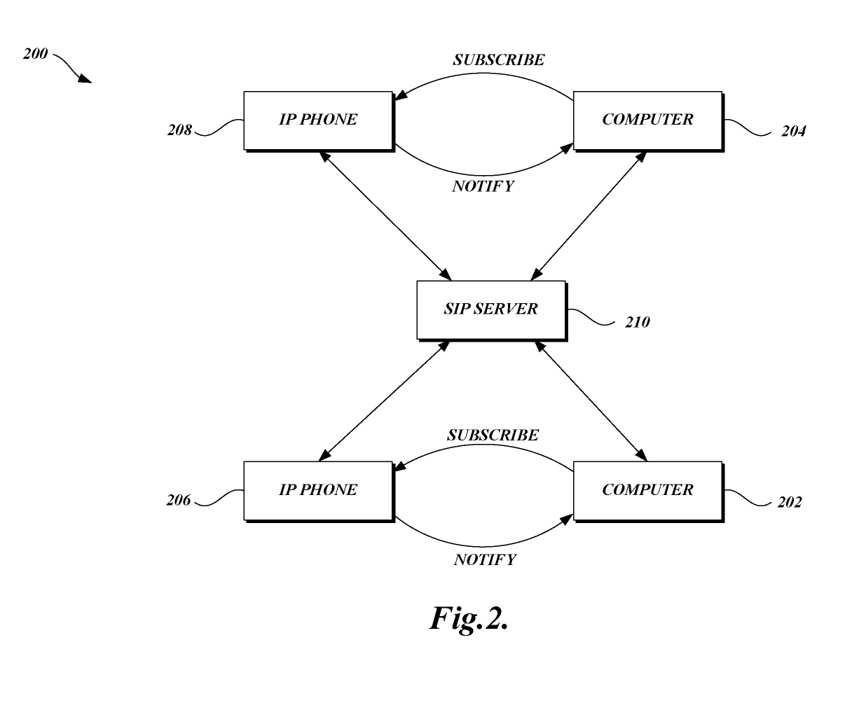

Now, with reference to FIG. 2, another exemplary networking environment 200 suitable for implementing the present invention will be described. FIG. 2 illustrates the computers 202-204 that are paired with the IP phones 206-208, respectively. Also, the networking environment 200 includes a SIP server 210 that is communicatively connected to each of the computers 202-204 and the IP phones 206-208.

Those skilled in the art and others will recognize that the SIP server 210 provides infrastructure to support real-time communications over an IP data network. In this regard, the Session Initiation Protocol (SIP) is an exemplary protocol for initiating, modifying, and terminating a network session that involves real-time communications. However, while the present invention is described in the context of SIP, other protocols may be used to exchange control information. In this regard and by way of example only, control information may be exchanged between local computing devices using SIP or similar protocol, such as, but not limited to, the Media Gateway Control Protocol (MGCP), Megaco/H.248, Network Control Program (NCP), Simple Object Access Protocol (SOAP), and the like. Moreover, control information may be exchanged across wide-area networks such as Internet utilizing SIP or similar protocol, such as, but not limited to, the Extensible Messaging and Presence Protocol (“XMPP”), H.323, and the like. When SIP is selected for the control protocol, session description information and messages will be exchanged over a SIP signaling channel and a media stream may be exchanged using any type of media channel that is capable of supporting real-time communications. For the purpose of discussion, a channel, as used herein, generally refers to any type of data or signal exchange mechanism.

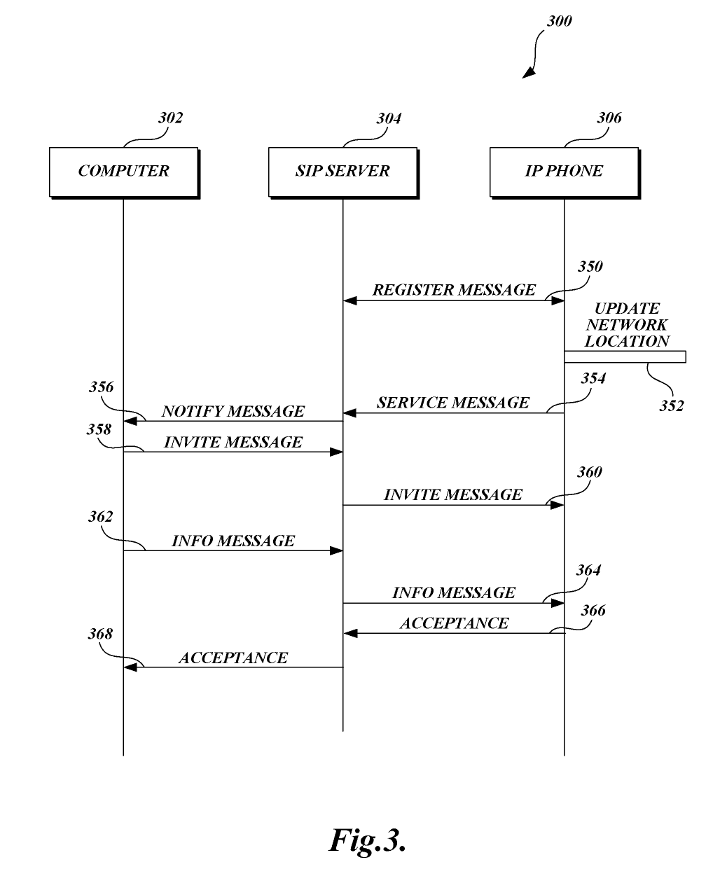

Generally described, aspects of the present invention perform processing to pair devices in a way that allows integration of the functions of the paired devices. In order to pair devices in this way, a secure communication channel is established so that the paired devices may freely exchange control information. In this regard, and as illustrated in FIG. 2, the computer 202 may send a subscribe message to the IP phone 206 during a set-up phase. In response, a notify message that includes features supported by the IP phone 206 is communicated back to the computer 202. Through this type of interaction described in more detail with reference to FIG. 3, initialization data is exchanged so that call control functions executed on the IP phone 206 may be remotely accessed from the computer 202.

Once the set-up phase is complete, the computer 202 may access functionality and be notified of events occurring on the IP phone 206. In this regard, when an event occurs on the IP phone 206, event data may be reported to the computer 202 in a notify message. Similarly, the computer 202 may transmit an info message with arguments for accessing various functions exposed on the IP phone 206. In other words, the invention supports the integration of telephony and computer-based functions without requiring an intermediary computing device to manage the exchange of control information. Instead, control information is exchanged directly between paired devices using an existing network infrastructure (e.g., the SIP server 210).

Now, with reference to FIG. 3, a set-up routine 300 for pairing devices so that control information may be freely exchanged will be described. Those skilled in the art and others will recognize that existing systems are capable of “pairing” a computer and an IP phone. However, these existing systems typically utilize an intermediary computing device to process and otherwise manage the exchange of control information. Generally described, the set-up routine 300 described with reference to FIG. 3 performs processing to “pair” a computer and an IP phone so that control information may later be freely exchanged without requiring a separate device.

As depicted in FIG. 3, the set-up routine 300 causes the computer 302, SIP server 304, and IP phone 306 to exchange control information so that a secure communication channel may be established between the computer 302 and the IP phone 306. At event 350, the set-up routine 300 causes a registration message to be transmitted from the IP phone 306 to the SIP server 304. In this regard, the registration message includes data that, among other things, uniquely identifies the network location of the registering device (e.g., the IP phone 306).

Those skilled in the art and others will recognize that control messages, such as the registration message transmitted at event 350, are typically exchanged in pairs. In this context, the first-in-time message is typically a request to perform an action with the second-in-time message being a response that acknowledges the successful receipt and completion of the request. For example, in response to the receipt and completion of the registration request transmitted at event 350, the SIP server 304 transmits an acceptance message (not illustrated) that acknowledges completion of the registration request. In some instances, the transmission of acceptance messages have not been described or illustrated herein because the message may not be important for an understanding of the present invention. Instead, the description below describes exemplary exchanges of control information that are based on the successful completion of requests.

At event 352, the set-up routine 300 updates the network location where functions for managing computer-telephony integration are performed. Generally described, computer-telephony integration refers to the management of call and message routing to appropriate devices and/or users. Traditionally, an intermediary computing device has been responsible for supporting computer-telephony integration between paired computing devices. For example, an intermediary computing device that supports computer telephony integration may forward a message that represents an incoming call to a user's IP phone and cause a pop-up message that represents the incoming call to be simultaneously displayed on the user's computer. Since the present invention does not require an intermediary computing device to route control messages that relate to a call, network data structures are updated to identify the network location where these functions will be managed. More specifically, at event 352, the set-up routine 300 causes the registering IP phone 306 to be identified as the network location where computer telephony integration for a user is managed. However, in an alternative embodiment, another device, such as the computer 302, may be used to manage computer telephony integration for a user.

Once the network data structures have been updated, the update is broadcast to all of the users' active endpoints. In the example depicted in FIG. 3, the IP phone 306 transmits a service message to the SIP server 304 to indicate that the IP phone 306 will manage computer telephony integration for a user, at event 354. Then, at event 356, the SIP server 304 transmits a notify message to broadcast the change to the computer 302.

As further illustrated in FIG. 3, at event 358, the set-up routine 300 causes the computer 302 to transmit an invite message to the SIP server 304 for the purpose of establishing a secure communication channel with the IP phone 306. Those skilled in the art and others will recognize that, in the context of SIP, an invite message is used to initiate a call conversation between network endpoints. However, the invite message transmitted, at event 358, is configured to establish a communication channel in which Non-Call Associated Signaling (“NCAS”) is performed. In other words, the communication channel established will transmit control information that relates to a call. Then, at event 360, the invite message that originated on the computer 302 is forwarded from the SIP server 304 to the IP phone 306. Upon acceptance of the invite message, the computer 302 and IP phone 306 may perform Non-Call Associated Signaling over a secure communication channel.

Those skilled in the art and others will recognize that the variety of commercially available IP phones may have different features and capabilities. In order to identify the features supported by the IP phone 306, the computer 302 generates and transmits a SIP-based info message that requests data describing the features of the IP phone 306. More specifically, an info message is transmitted from the computer 302 to the SIP server 304, at event 362. Then, at event 364, the SIP server 304 forwards the info message to the IP phone 306.

In response to receiving the info message, data that describes the features of the IP phone 306, including primitives accessible from the IP phone 306, is generated. As described in further detail below, aspects of the present invention implement primitives so that a computer may (1) access functions available from an IP phone, and (2) be notified of events that occur on the IP phone. Once the list of features that includes primitives supported by the IP phone 306 is generated, an acceptance message that includes this data is transmitted from the IP phone 306 to the SIP server 304, at event 366, and then forwarded to the computer 302 at event 368. When the computer 302 acknowledges receipt of the acceptance message, the set-up routine 300 terminates.

Once the set-up routine 300 completes execution, paired devices may freely exchange control messages related to a call without using an intermediary computing device. In this regard and in accordance with one embodiment, a computer may access functionality exposed on a IP phone by transmitting a SIP-based info message with the appropriate arguments. Similarly, a computer may be notified of events that occur on the IP phone by receiving a notify message with arguments that describe the event.

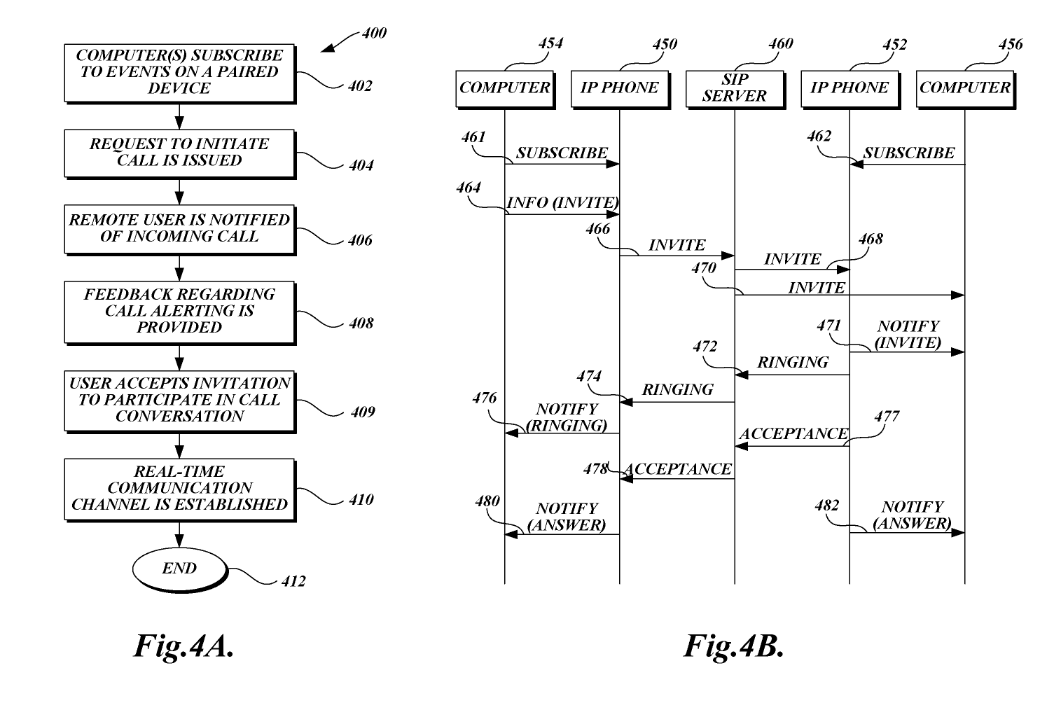

Now, with reference to FIGS. 4A-4B, an exemplary call initiation routine 400 that exchanges control information to establish a call in accordance with an embodiment of the present invention is shown. As illustrated in FIG. 4B and described further detail below, a request to initiate a call is generated from an IP phone 450 that is paired with the computer 454. The received request is forwarded over the SIP server 460 to the IP phone 452 that is paired with the computer 456. While this example utilizes two IP phones 450-452 and two computers 454-456, any number and combination of devices may be used with embodiments of the present invention. For example, at least one user may not utilize a computer to participate in a call conversation. In yet another example, a user may be associated with a PSTN telephone which utilizes a gateway to bridge communications over IP and PSTN networks.

As illustrated in FIG. 4A, the call initiation routine 400 begins at block 402 where one or more computers subscribes to the events that occur on a paired IP phone. For illustrative purposes, an exemplary exchange of control information between paired devices that corresponds to steps performed by the call initiation routine 400 (FIG. 4A) is depicted in FIG. 4B. In this regard, each of the computers 454-456 transmits a subscribe message to a paired IP phone, at events 461 and 462 respectively. In this illustrative embodiment, each subscribing computer 454-456 has previously obtained information that describes the features of an IP phone.

In this exemplary embodiment, a request to initiate a call is issued at block 404 by a user associated with the computer 454. In order to issue the request, the user may activate a control accessible from an application program on the computer 454. However, those skilled in the art and others will recognize that a request to initiate a call may be generated in other ways without departing from the scope of the claimed subject matter.

Once the request is issued, the call initiation routine 400 proceeds to block 406 where a remote user is notified of the incoming call. In this illustrative embodiment, notifying the remote user of the incoming call includes transmitting a series of control messages. For example, as depicted in FIG. 4B, an info message with argument(s) configured to invite another user to participate in a call is transmitted from the computer 454 to the IP phone 450, at event 464. By way of example only, the info message may be transmitted over an NCAS channel established by the set-up routine 300 (FIG. 3). In accordance with one embodiment, the info message is configured to access a primitive exposed on the IP phone to generate the call. Moreover, the info message may contain all of the necessary information to identify a remote user, such as an Address of Record (“AOR”) that is similar to a telephone number in a PSTN environment. In response to receiving the info message, the IP phone 454 converts the received message into a SIP-based invite message for transmission to the SIP server 460, at event 466.

In this illustrative embodiment, the SIP server 460 causes the received invite message to be “forked” for separate transmission to paired devices. Once the invite message has been forked, one version of the message is transmitted from the SIP server 460 to the IP phone 452, at event 468. Those skilled in the art and others will recognize that receipt of the invite message may cause the IP phone 452 to alert the user of an incoming call. For example, the IP phone 452 may “ring” when the invite message is received. Also, at event 470, another version of the invite message is forwarded from the SIP server 460 to the computer 456. Then, at event 471, a notify message with arguments that indicate an incoming call is being received on the IP phone 452 is transmitted from the IP phone 452 to the computer 456. When this message is received, processing may be performed on the computer 456 to visually notify the user about the incoming call through the use of a pop-up window or other graphically-based mechanism.

Returning to FIG. 4A, at block 408, the call initiation routine 400 provides feedback about the call alerting (e.g., ringing) being performed on the IP phone 452. In other words, information is made available to the initiating user that indicates the IP phone 452 is ringing. In the illustrative embodiment depicted in FIG. 4B, providing feedback about the call-alerting being performed on the IP phone 452 includes transmitting a SIP-based ringing message from the IP phone 452 to the SIP server 460, at event 472. Then, the SIP server 460 forwards the ringing message to the IP phone 450, at event 474. When the ringing message is received, audio feedback may be provided to indicate that the target phone is ringing. Moreover, processing performed on the IP phone 450 converts the received ringing message into a notify message with arguments to indicate that the IP phone 452 is ringing for transmission to the computer 454, at event 476. When the notify message is received on the computer 454, processing may be performed to visually notify a user that the IP phone 452 is ringing.

With reference again to FIG. 4A, a user associated with the IP phone 452 accepts the invitation to participate in the call conversation, at block 409. Then, once the call is answered, the call initiation routine 400 proceeds to block 410 where a real-time communication channel is established. In this embodiment, establishing the real-time communication channel includes transmitting control messages to both local and remote devices. More specifically, as depicted in FIG. 4B, an acceptance message is transmitted from the IP phone 452 to the SIP server 460, at event 477. Then, the SIP server 460 forwards the acceptance message to the IP phone 450, at event 478. Moreover, processing performed on the IP phone 450 converts the received message into a notify message with arguments indicating that the call was answered for transmission to the computer 454, at event 480. When the notify message is received on the computer 454, a graphical user interface may be updated to indicate that the call was answered. Similarly, in this illustrative embodiment, a notify message that indicates the call has been answered is also transmitted from the IP phone 452 to the computer 456, at event 482. As a result, a graphical user interface presented to this user may also be updated to reflect the acceptance of incoming call.

Once the control information for establishing the call conversation is exchanged, the call initiation routine 400 proceeds to block 412, where it terminates. Accordingly, users that agree to participate in a call conversation may now freely exchange audio data until the call is terminated. As described in further detail below, paired devices may continue to exchange control information during a call so that each paired device may participate and receive notice of events occurring during the call.

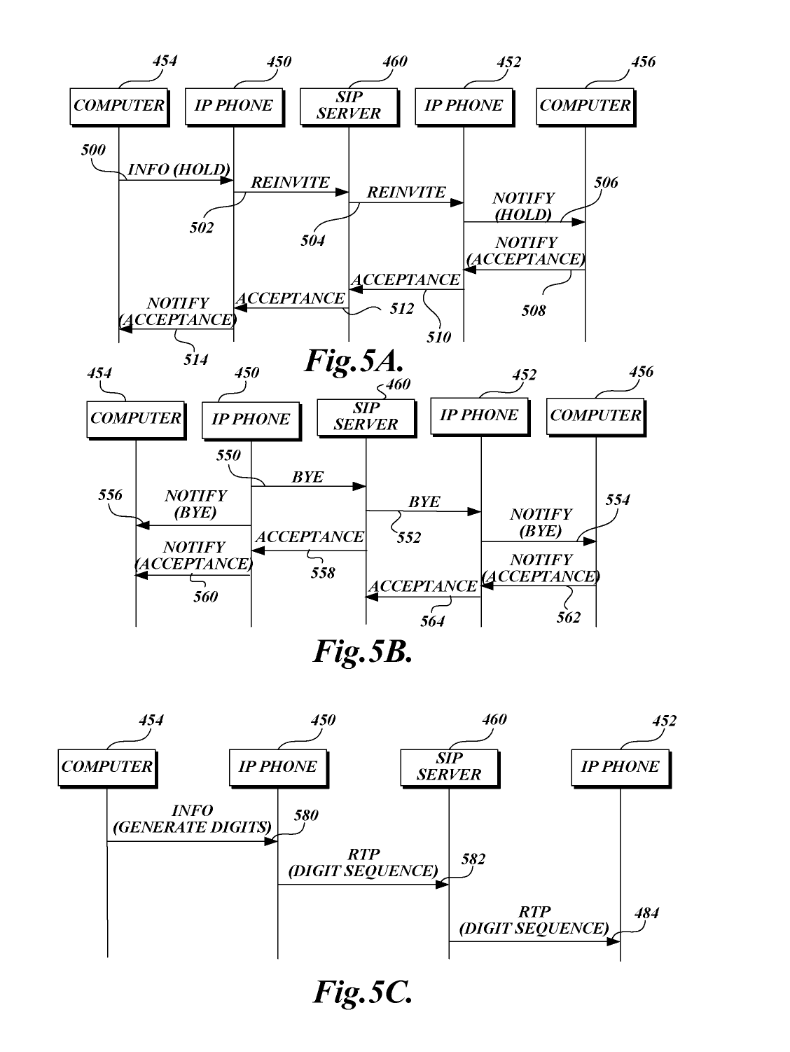

Now, with reference to FIGS. 5A-5C, an exemplary exchange of control information for performing various functions supported by the present invention will be described. In this regard, FIGS. 5A-5C each depict the IP phones 450-452 and computers 454-456 described above with reference to FIG. 4. For illustrative purposes, the description below describes an exemplary exchange of control information when preexisting communication channels exist between devices participating in a call.

Generally described, FIG. 5A illustrates an exemplary exchange of control information that occurs when a user employs a computer to place another user on “hold.” In other words, control information is exchanged for the purpose of temporarily suspending the transmission of an audio stream until additional input is received. As illustrated in FIG. 5A, when input is received on the computer 454 to place another user on hold, an info message with arguments indicating that the call will be held is transmitted from the computer 454 to the IP phone 450, at event 500. Moreover, when the hold request is pending, a graphical user interface on the computer 454 may be updated accordingly. In response to receiving the info message, the IP phone 454 may convert the message into a SIP-based re-invite message with arguments for suspending the transmission of an audio stream. The SIP-based re-invite message is transmitted to the SIP server 460, at event 502. Then, the SIP server 460 forwards the re-invite message to the IP phone 452, at event 504. Upon receipt of the re-invite message, communication of the audio stream between the IP phones 450 and 452 is suspended.

The IP phone 452 converts the received re-invite message into a notify message that is suitable for transmission on a NCAS communication channel. Then, the notify message is transmitted from the IP phone 452 to the computer 456, at event 506. When received, processing may be performed on the computer 456 to notify a user that the call is on hold. In this example, when a notify message is transmitted from the computer 456 to the IP phone 452, at event 508, a series of control messages is transmitted back to the original user to indicate that the hold request was received. More specifically, an acceptance message is transmitted from the IP phone 452 to the SIP server 460, at event 510. Then, the SIP server 460 forwards the acceptance message to the IP phone 450, at event 512. Finally, the IP phone 450 converts the received acceptance message into another notify message with arguments indicating that the call is on hold. Then, the notify message is transmitted from the IP phone 450 to the computer 454, at event 514. When the notify message transmitted from the IP phone 450 to the computer 454 is received, a graphical user interface on the computer 454 may be updated to indicate that the call was successfully placed on hold.

In order to retrieve a call that is on hold, control messages may be exchanged using the same process as described above with reference to FIG. 5A. In this regard, if a command to retrieve a held call is generated on the computer 454, the appropriate info message with arguments for resuming transmission of an audio stream is sent from the computer 454 to the IP phone 450. The received notify message is converted into a message type that may be transmitted using the SIP server 460 and ultimately to devices associated with a remote user.

Those skilled in the art and others will recognize that the exchange of control information described with reference to FIG. 5A is merely exemplary. Control information may be exchanged in a different order than depicted in FIG. 5A without departing from the scope of the claimed subject matter. For example, an IP phone may be configured with a hardware-based button to place a call on hold. In this instance, the hold command is not generated from a computer. Instead, the command is generated on an IP phone with a paired computer receiving notice of the command in a notify message.

Now, with reference to FIG. 5B, an exemplary exchange of control information that occurs when a user terminates a call in accordance with another embodiment of the present invention will be described. As illustrated in FIG. 5B, when input is received on the IP phone 450 to terminate the call, a SIP-based bye message is transmitted from the IP phone 450 to the SIP server 460, at event 550. Then, the SIP server 460 forwards the bye message to the IP phone 452, at event 552. The IP phone 452 converts the received bye message into a notify message that contains arguments to indicate that the call has been terminated. Then, the notify message is transmitted from the IP phone 452 to the computer 456, at event 554. When the notify message is received, a graphical user interface on the computer 454 may be updated to indicate that the call was terminated.

A notify message that contains arguments to indicate that the call has been terminated is also transmitted from the IP phone 450 to the computer 454, at event 556. Moreover, acceptance messages may be successively transmitted from the SIP server 460 to the IP phone 450 and computer 454, at events 558 and 560, to confirm that the message to terminate the call was received. Then information may be presented on the computer 454 to indicate that the call was successfully terminated. Also, acceptance messages may be successively transmitted from the computer 456 to the SIP server 460, at events 562 and 564, to acknowledge that information about terminating the call was successfully received.

Now, with reference to FIG. 5C, an exemplary exchange of control information that allows a series of digits to be generated from a computer that is associated with an IP phone will be described. As illustrated in FIG. 5C, when a software-based control available from the computer 454 is activated to generate a call, an info message is transmitted from the computer 454 to the IP phone 450, at event 580. In this exemplary embodiment, an argument in the info message contains a series of digits input by a user. When the info message is received, the IP phone 450 converts data in the message into a series of packets that adhere to the real-time protocol. In one exemplary embodiment, data in the received message is converted into a RTP payload using processes described in the Internet Engineering Task Force Request for Comments document 2833. Then, at event 582, an RTP-based payload is transmitted from the IP phone 450 to the SIP server 460. The SIP server 460 forwards the RTP-based message to the IP phone 452, at event 484.

In a similar fashion to the process depicted in FIG. 5C, a user may increase/decrease the volume of a call and/or set a call to mute. However, in this instance, communication with a remote device that is associated with another user is not necessary. Instead, when setting the volume of a call, an info message with the appropriate arguments for accessing volume-based functions may be transmitted from a computer to an IP phone.

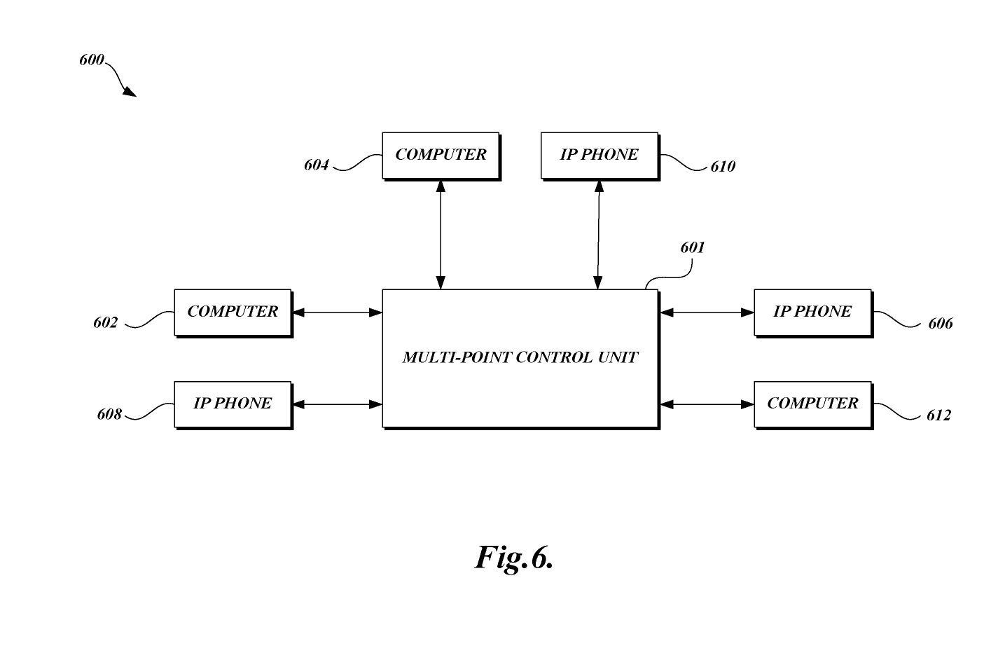

Increasingly, systems are being developed to manage conferences between multiple users. In this regard, FIG. 6 illustrates a networking environment 600 that includes a multi-point control unit 601 and a plurality of conference endpoints. More specifically, the networking environment 600 maintains network endpoints that include the computers 602-606 that are each paired with the IP phones 608-612, respectively. Generally described, the multi-point control unit 601 collects information about the capabilities of devices that will participate in the network conference. Based on the information collected, properties of the conference between the network endpoints may be established.

In accordance with one embodiment, aspects of the present invention are implemented in the networking environment 600 so that paired devices may each participate in a network conference. In this regard, instead of paired devices directly communicating info and notify messages, the multi-point control unit 601 manages the exchange of control information so that appropriate devices may be invited to participate in the network conference. For example, if a user initially connects to a network conference using the computer 602, SIP-based notifications (e.g., conference invite, re-invite, update, etc.) may be transmitted from the computer 602 to the multi-point control unit 601. When received, the multi-point control unit 601 distributes messages to other network endpoints that will participate in the network conference, such as the computers 604-606 and the IP phones 608-612. In this regard, the IP phone that is paired with the computer 602 (e.g., the IP phone 608) is invited to participate in the network session by receiving an invite message in the same way as other network endpoints. If participation in the network conference is initiated from the IP phone 608, then SIP-based notifications may be transmitted from the IP phone to the multi-point control unit 601. When received, the multi-point control unit 601 distributes messages to other network endpoints that will participate in the network conference, including the computer 602.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a networking environment that includes a computer associated with an IP phone, a method of allowing the computer to initiate a call with a remote user using the IP phone, the method comprising:
exposing one or more functions executed on the IP phone to the computer;
in response to receiving a request generated on the computer to initiate the call:
transmitting a first control message from the computer to the IP phone;
wherein the first control message is configured to access a function exposed on the IP phone for generating the call to the remote user; and
converting the first control message into a second control message that is configured to notify the remote user of the call when transmitted over an IP data network.

2. The method as recited in claim 1, further comprising:
receiving notice of the call on an IP phone associated with the remote user; and
causing a computer associated with the remote user to provide notice of the incoming call.

3. The method as recited in claim 2, wherein causing a computer associated with the remote user to provide notice of the incoming call includes converting the second control message into a message type that may be transmitted over a Non-Call Signaling Channel.

4. The method as recited in claim 1, wherein exposing one or more functions executed on the IP phone to the computer includes defining communication primitives that may be called from the computer.

5. The method as recited in claim 1, wherein transmitting a first control message from the computer to the IP phone includes configuring a SIP-based message to access a communication primitive that is exposed on the IP phone.

6. The method as recited in claim 1, wherein transmitting a first control message includes establishing a communication channel between the IP phone and the computer.

7. The method as recited in claim 1, wherein converting the first control message into a second control message includes receiving data in the form of a sequence of digits or SIP-based uniform resource identifier and inserting the data into packets that adhere to the real-time protocol.

8. The method as recited in claim 1, wherein converting the first control message into a second control message includes:
causing the computer to transmit a SIP-based info message with information that identifies the remote user; and
using information in the SIP-based info message to construct a SIP-based notify message for transmission on the IP data network.

9. A computer-readable medium containing computer-readable instructions which, when executed, performs a method of pairing a computer and an IP phone so that control information for handling computer telephony integration may be directly exchanged without using an intermediary computing device, the method comprising:
changing the network location where functions for handling computer telephony integration are performed to the IP phone;
establishing a communication channel between the IP phone and the computer suitable for exchanging control information; and
exposing functions of the IP phone for remote access from the computer.

10. The computer-readable medium as recited in claim 9, wherein changing the network location where functions for handling computer telephony integration are performed includes broadcasting the network location of the IP phone to a set of network endpoints.

11. The computer-readable medium as recited in claim 9, wherein establishing a communication channel between the IP phone and the computer includes exchanging a set of SIP-based notify and info messages.

12. The computer-readable medium as recited in claim 9, wherein a function exposed on the IP phone includes a function to hold/resume a call from the computer.

13. The computer-readable medium as recited in claim 9, wherein a function exposed on the IP phone includes a function that allows the volume of the call to be increased and decreased from the computer.

14. The computer-readable medium as recited in claim 9, wherein a function exposed on the IP phone includes a function for muting the volume of the call from the computer.

15. The computer-readable medium as recited in claim 9, wherein a function exposed on the IP phone includes a function that allows a network conference to be established from the computer.

16. The computer-readable medium as recited in claim 9, wherein a function exposed on the IP phone includes a function that allows a call to be initiated from the computer while audio data is transmitted using the IP phone.

17. The computer-readable medium as recited in claim 9, wherein exposing functions of the IP phone that may be remotely accessed from the computer includes transmitting a SIP-based info message from the computer to the IP phone that identifies features of the IP phone.

18. A computer system that supports the integration of computer and telephony functions between paired devices, comprising:
an IP phone for communicating audio data over an IP data network with a remote user, wherein the IP phone is further configured to:
allow a computer to access functions that are exposed on the IP phone from a remote network location;
notify the computer of events that occur on the IP phone;
a computer configured to:
access functions on the IP phone through the transmission of control messages; and
receive notice of events that occur on the IP phone.

19. The system as recited in claim 18, further comprising a multipoint control unit configured to manage the exchange of control information to enable the IP phone and computer to participate in a network conference.

20. The system as recited in claim 18, wherein the computer is further configured to:
allow the IP phone to access functions that are exposed on the computer; and
wherein a function exposed on the computer allows the IP phone to initiate a call with a remote user using the computer.
